(19) United States
(12) Patent Application Publication
(10) Pub. No.: US 2004/0088995 A1
(43) Pub. Date: May 13, 2004

(54) Method for cooling a gas turbine and gas turbine installation

(76) Inventor: Sergej Reissig, Erlangen (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/702,712

(22) Filed: Nov. 6, 2003

(30) Foreign Application Priority Data
Apr. 29, 2002 (WO) PCT/DE02/01559
May 10, 2001 (DE) 10122695.0

(51) Int. Cl. F02C 7/16

(52) U.S. Cl. 60/772; 60/806

(57) ABSTRACT

The invention relates to method for cooling a gas turbine according to which compressed air is extracted from a compressor connected upstream from the gas turbine for feeding said gas turbine and is used as cooling air. Cooling efficiency and yield are increased by means of cooling the compressed air through heat exchange with an air stream and feeding the gas turbine with cooled compressed air for cooling it. The invention also relates to a gas turbine installation comprising a gas turbine and a compressor connected upstream from said gas turbine, with at least one cooling air duct extending from the compressor. The primary side of a heat exchanger is connected to the air cooling duct and its secondary side is connected to a duct through which an air stream flows for supplying the heat exchanger.

The invention relates to a method for cooling a gas turbine, according to which compressed air is extracted from a compressor connected upstream from the gas turbine and fed to said gas turbine as cooling air. The invention also relates to a gas turbine installation with a gas turbine and a compressor connected upstream from the gas turbine, wherein at least one cooling air duct extends from the compressor, via which compressed air can be extracted from the compressor and fed to the gas turbine as cooling air.

In a turbo machine, for example in a gas turbine, effective work is produced by a flowing, hot action fluid, e.g. a hot gas, as a result of the expansion of said fluid. As far as increasing the efficiency of a turbo machine is concerned, attempts are made for example to achieve the highest possible temperature of the hot action fluid. The components exposed directly to the hot action fluid are therefore subject to a particularly high level of thermal loading. In the case of a gas turbine, this is true in particular of the blade system in the turbine (vanes and blades) and the wall elements of the turbine bounding the space containing the flowing hot action fluid. It is therefore a question of finding suitable materials for such components, which have adequate strength at the highest possible temperatures and of developing methods with which such components can be cooled in order to be able to utilize the high temperatures. In a gas turbine the coolant required for cooling purposes is generally extracted from a compressor coupled to the turbine in the form of cooling air. During this process the cooling air is tapped off from a stage of the compressor with corresponding pressure and corresponding temperature and fed to the critical areas of the gas turbine which require cooling. In order to keep the loss of efficiency associated with this cooling air extraction as low as possible, there is an intensive search for cooling strategies, which ensure the most efficient utilization of coolants possible.

A coolable stator set for a gas turbine drive mechanism is disclosed in U.S. Pat. No. 4,642,024. The stator set has an external air seal as well as an upstream bracket and a downstream bracket. The brackets support the external air seal with the help of interlocking elements over a flow path for the working medium. This results in a structural division into three of the air seal into a downstream and upstream peripheral area and a central area located between the peripheral areas. To cool the external air seal with cooling air, first of all impact cooling takes place in the central area. In this process the cooling air is tapped off from the compressor of the gas turbine drive mechanism. The peripheral areas, which cannot be subject to the direct action of the cooling air due to the brackets, are cooled by feeding some of the collected cooling air through the brackets to allow impact cooling of the peripheral areas. For this purpose metering holes extend through the brackets, in order to feed the cooling air into the upstream and downstream peripheral areas of the same external air seal.

A cooling device for cooling a first stage of a gas turbine with a first vane and a first blade by means of cooling air emerges from DE 197 33 148 C1. The first vane comprises a platform, which represents a wall element, which bounds the flow channel containing a hot action fluid, i.e. the hot gas. A first chamber and a second chamber adjacent to the first in the direction of flow are located against the platform of the first vane. Between these two chambers is a wall, which is inset into the platform of the vane. The first chamber is supplied with a first cooling air stream via a first cooling air feed system by a first cooling air supply. The first cooling air stream is fed through the platform and released into the flow channel via the first stage of the gas turbine. The second chamber is correspondingly supplied with a second cooling air supply by means of a second cooling air feed system with a second cooling air stream, said cooling air stream then being released through the platform into the flow channel in the first stage. In this process the first cooling air supply system is operated with compressor air at a first pressure, the second cooling air supply system with compressor air at a second pressure from an appropriate extraction point on the compressor, wherein the second pressure is lower than the first pressure. In this way the vane is subject to the action of and cooled by independent coolant streams at different pressures.

In WO 00/60219 a turbo machine is disclosed, in particular a gas turbine, with a coolable arrangement with a first wall element and with a second wall element axially adjacent to the first wall element. A method for cooling an arrangement in a turbo machine with a first wall element and with a second wall element adjacent to the first wall element is also disclosed, wherein the wall elements are subject to the action of a coolant, in particular cooling air from a compressor. The coolant is reused after the impact cooling of the first wall element to cool the second wall element. This results in particular in the advantage of multiple utilization of the coolant to cool different wall elements, thereby reducing the use of coolant in a gas turbine.

The object of the invention is to specify a method for cooling a gas turbine, which allows greater cooling efficiency and thereby also greater gas turbine efficiency compared with cooling methods known from the prior art. A further object of the invention is to specify a gas turbine installation, which in particular allows the implementation of the cooling method.

The first-mentioned object is achieved according to the invention by a method for cooling a gas turbine, in which compressed air s extracted from a compressor connected upstream from the gas turbine and fed to the gas turbine as cooling air, wherein the compressed air is cooled in the exchange of heat with an air stream and cooled compressed air is fed to the gas turbine.

The invention is based on the knowledge that the standard methods used to date for cooling a gas turbine have disadvantages with regard to cooling efficiency, when extracted air from the compressor is used to cool the components of the gas turbine subject to a high level of thermal loading. During the operation of a gas turbine the blades, vanes and combustion chamber of the gas turbine in particular have to be cooled. The temperature of the cooling air required for cooling has a value, which is adjusted according to the compression process. Generally, depending on the gas turbine chip, it is approx. 330 to 420° C. The air extracted from the compressor is therefore used at a comparatively high temperature as cooling air to cool the critical areas of the gas turbine. Also extraction of the cooling air from the compressor reduces the gas mass flow upstream from the turbine, reducing the efficiency of the gas turbine correspondingly. In order to be able to achieve higher levels of efficiency, the turbine entry temperature of the hot gases must generally be increased. The rise in gas temperature upstream from the gas turbine requires larger quantities of cooling air. In order to prevent the efficiency losses as a result, cooling processes have to be improved or optimized.

The invention takes a completely different approach to improving the cooling of a gas turbine, in order to achieve a higher level of efficiency of the gas turbine as a result. It is achieved by not using the compressed air extracted from the compressor, which is fed to the gas turbine as cooling air for cooling purposes, at comparatively high temperatures as was previously the standard. Rather the compressed air is cooled after extraction from the compressor. Cooling is achieved here in the exchange of heat with an air stream. The compressed air cooled in the exchange of heat is then fed to the gas turbine for cooling purposes. The significantly lower temperature of the cooling air than that achieved with standard cooling methods advantageously allows either the quantity of cooling air, i.e. the cooling air mass flow to be reduced or the turbine entry temperature of the hot gas driving the turbine to be increased. Both measures result in an increase in the efficiency of the gas turbine, wherein an increase of more than 1% can be achieved.

Preferably the air stream is conducted independently of the compressed air with regard to flow technology. Both the air stream and the stream of compressed air, which is extracted from the compressor, can therefore be conducted separately and their mass flow can be adjusted separately. During the exchange of heat, an air-air heat exchange takes place, wherein during the heat exchange process the compressed air interacts with the air stream. This causes the compressed air from the compressor to be cooled and the air stream to be heated correspondingly.

Preferably the compressed air is cooled in the heat exchange by 120° C. to 150° C., in particular to 130° C. to 140° C. The compressed air thus cooled is used as cooling air to cool the gas turbine, wherein a clearly reduced temperature is provided for the cooling air compared with conventional cooling methods. The comparatively low temperature of the cooling air means that this can absorb more heat when it acts on the components of the gas turbine subject to high levels of thermal loading and dissipate it from the gas turbine. A higher level of cooling efficiency is then advantageously achieved in relation to the cooling air mass flow used.

Preferably an air stream with a temperature of 90° C. to 115° C., in particular 100° C. to 110° C. is used for the exchange of heat. It is further preferable for an air stream with a maximum pressure of 2 bar to 3 bar, in particular 2 bar to 2.5 bar, to be used for the exchange of heat. The air stream can be adjusted in respect of temperature and pressure, so that a predefinable cooling of the compressed air and therefore the temperature of the cooling air can be adjusted during the exchange of heat with the compressed air. The air stream can for example be extracted from an air compressor to be provided independently of the gas turbine compressor at an appropriate stage of the air compressor.

In a particularly preferred embodiment the air stream heated during the exchange of heat is fed to an air turbine and expanded there in a manner that provides work output. The energy of the air stream heated in the exchange of heat can as a result very advantageously be utilized to generate further energy. The air turbine can hereby be coupled to a generator, so that electrical energy can also be generated. The air turbine can at the same time be used to drive the air compressor, from which the air stream is extracted to cool the compressed air. In this particularly advantageous embodiment of the cooling method the thermal discharge obtained in the heat exchange process from the cooling of the compressed air is used to obtain further useful energy. In the heat exchange process the compressed air is cooled and the air turbine air stream is heated. The air stream heated thus is fed to the air turbine, where it expands, thereby generating mechanical or electrical energy. The compressed air cooled in the heat exchange process typically to around 130° C. to 140° C. is fed to the gas turbine as cooling air. Use of the heated air stream to drive an air turbine results in the generation of additional energy, which in turn contributes to a further increase in efficiency.

The object relating to a gas turbine installation is achieved according to the invention by a gas turbine installation, in particular for implementing the method disclosed above, with a gas turbine and a compressor connected upstream from said gas turbine, wherein at least one cooling air duct extends from the compressor, via which compressed air can be extracted from the compressor and fed to the gas turbine as cooling air, wherein the primary side of an air-air heat exchanger is connected to the cooling air duct, and its secondary side is connected to a duct, via which an air stream can flow through the heat exchanger.

This new circuit design for a gas turbine installation achieves particularly efficient cooling of the components of the gas turbine subject to particularly high levels of thermal loading. The compressed air extracted from the compressor connected upstream from the gas turbine is cooled in the air-air heat exchanger by the primary-side connection. The air stream flowing through the air-air heat exchanger via the duct on the secondary side absorbs heat from the compressed air, with the result that the temperature of the air stream rises.

In a preferred embodiment the duct is connected upstream of the heat exchanger to an extraction point on an air compressor to extract the air stream.

The air compressor is hereby advantageously an air compressor that is independent of the compressor connected upstream from the gas turbine, said air compressor being used to supply the air stream. The extraction point for the air stream can be selected on the basis of the required pressure and temperature levels of the air stream.

In a particularly preferred embodiment the duct opens out downstream from the heat exchanger into an air turbine connected downstream from the air compressor. In this way the air stream heated in the heat exchanger can be used to drive the air turbine and additional energy can be generated, for example if the air turbine drives an electric generator. The air turbine hereby advantageously also drives the air compressor, from which the air stream is extracted for cooling the compressed air from the compressor of the gas turbine.

It is also possible for a number of air-air heat exchangers to be provided, for example two, to the primary side of which a cooling air duct is connected and to the secondary side of which a duct is connected. In this way for example a first cooling air duct can extend from a first pressure stage of the gas turbine compressor and a second cooling air duct can extend from a second pressure stage that is different from the first pressure stage. A first duct extends correspondingly from a first stage of the air compressor assigned to the air turbine and a second duct from a second stage of the air compressor. The first cooling air duct and the first duct are hereby connected to a first air-air heat exchanger and the second cooling air duct and the second duct to a second air-air heat exchanger, so that cooling air is available at a different pressure and/or temperature level to cool the gas turbine. This circuit design allows particularly efficient action of the cooling air on the gas turbine as appropriate to cooling requirements to be achieved.

Further advantages of the gas turbine installation emerge in a similar manner to the advantages of the method for cooling a gas turbine disclosed above.

The method for cooling a gas turbine and the gas turbine installation are described in more detail using exemplary embodiments shown in the drawing. These show the following, to some extent in diagrammatic and simplified form:

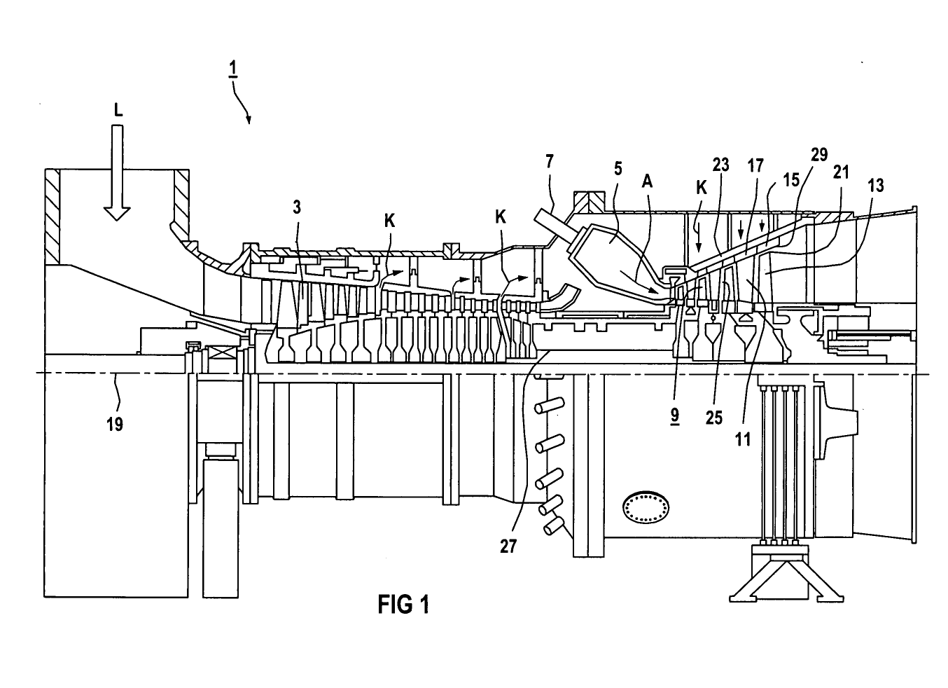

FIG. 1 a half section through a gas turbine with compressor, combustion chamber and turbine,

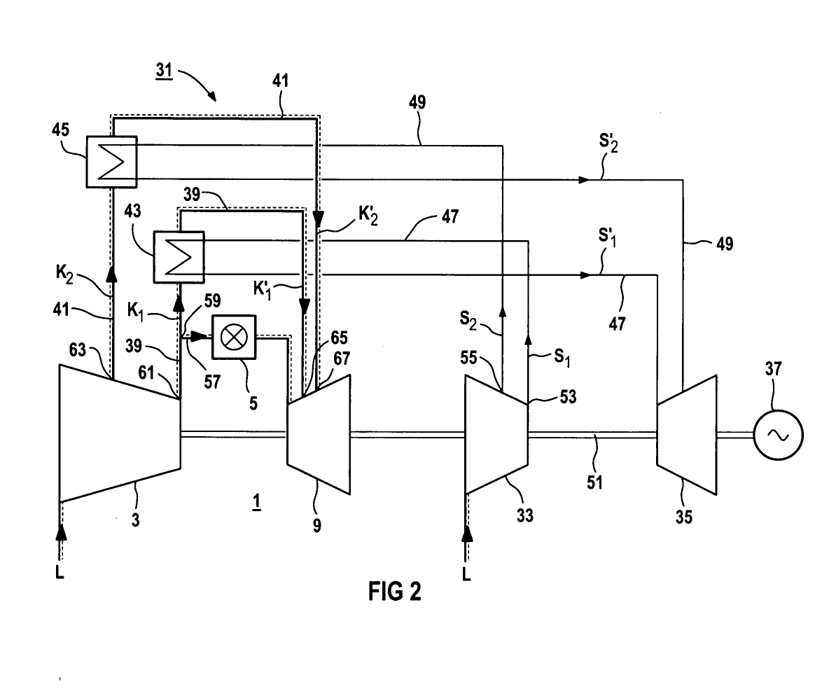

FIG. 2 a gas turbine installation according to the invention.

The same references have the same significance in each of the figures.

FIG. 1 shows a half section through a gas turbine 1. The gas turbine 1 comprises a compressor 3 for combustion air, a combustion chamber 5 with combustion chamber 7 for a fluid or gaseous fuel and a turbine 9 to drive the compressor 3 and a generator (not shown in FIG. 1). In the turbine 9 fixed vanes 11 and rotatable blades 13 are arranged on respective margins, not shown in more detail in the half section, extending radially along the axis of rotation 19 of the gas turbine 1. A pair comprising a ring of vanes 11 (vane ring) and a ring of blades 13 (blade ring) one after the other along the axis of rotation 19 is hereby referred to as a turbine stage. Each vane 11 comprises a platform 17, which is arranged on the inner turbine housing 23 to secure the respective vane 11. The platform 17 thereby represents a wall element in the turbine 9. The platform 17 is a component that is subject to a very high level of thermal loading, forming the outer boundary for a hot action fluid A, in particular the hot gas channel 25 in the turbine 9. The blade 13 is secured on the turbine wheel arranged along the axis of rotation 19 of the gas turbine 1. A guide ring 15 is arranged as a wall element in the gas turbine 1 between the platforms 17 of two axially separated, adjacent vanes 11. The guide ring 15 and the platforms 17 of the vanes 11 each comprise a hot side 29, which is exposed during the operation of the gas turbine 1 to the hot action fluid A, in particular the hot gas. The hot side 29 of the guide ring 15 is thereby separated radially from the outer end 21 of the blade 13 by a gap.

The platform 17 of the vane 11 and the axially adjacent guide ring 15 are both coolable wall elements, which are subject to the action of a coolant K for cooling purposes. During the operation of the gas turbine 1, fresh air L is taken in from the ambient air. The air L is compressed in the compressor 3 and preheated as a result at the same time. In the combustion chamber 5 the air L is combined with the fluid or gaseous fuel and burned. Part of the air L extracted beforehand from the compressor 3 via suitable extraction points is used as cooling air K to cool the turbine 9, in particular the turbine stages. Here for example the first turbine stage is subject to a turbine entry temperature of around 750° C. to 1200° C. with the action of a hot action fluid A, the hot gas. Expansion and cooling of the hot action fluid A, in particular the hot gas, flowing through the turbine stages takes place in the turbine 9.

FIG. 2 shows the circuit design of a gas turbine installation 31 according to the invention. The gas turbine installation 31 hereby comprises a gas turbine 1. The gas turbine 1 comprises a turbine 9 and a compressor 3 connected upstream from the turbine 9 as well as a combustion chamber 5 for burning a fuel. The gas turbine installation 31 also comprises an air turbine 35 and an air compressor 33 assigned to the air turbine 35 and connected upstream from it. The gas turbine 1, the air turbine 35 and the air compressor 33 are arranged on a common shaft 51. To generate electrical energy, the gas turbine installation 31 has a generator 37, which can be driven via the shaft 51. A cooling air duct 39 extends from the compressor 3 at a cooling air extraction point 61. A further cooling air duct 41 extends from a further cooling air extraction point 63 on the compressor 3.

A duct 47 and a further duct 49 extend from the air compressor 33 assigned to the air turbine 35, wherein the duct 47 is connected to an extraction point 53 and the further duct 49 is connected to an extraction point 55 of the air compressor 33. The primary side of a heat exchanger 43, 45 is connected to the cooling air duct 39, 41. The secondary side of the heat exchanger 43, 45 is connected to the duct 47, 49 via which an air stream S₁, S₂ can flow through the heat exchanger 43, 45. Looking in the direction of flow of the air stream S₁, S₂, upstream from the heat exchanger 43, 45 the duct 47, 49 is connected to a respective extraction point 53, 55 of the air compressor 33 to extract the air stream S₁, S₂. Downstream of the heat exchanger 43, 45 the duct 47, 49 opens out into the air turbine 33 connected downstream from the air compressor 33. Looking in the direction of flow of the compressed air K₁, K₂, the cooling air duct 39, 41 opens out into the turbine 9 downstream of the heat exchanger 43, 45, wherein each area 65, 67 of the gas turbine 1 that is subject to thermal loading can be cooled.

The cooling air duct 39 is assigned to the highest compressor stage of the compressor 3, so that correspondingly highly compressed air K₁ can be extracted via the cooling air extraction point 61. A branch duct 57, which is connected to the combustion chamber 5, extends from the cooling air duct 39. Combustion air can be fed to the combustion chamber 5 to burn a fluid or gaseous fuel via said branch duct 57. After combustion the hot combustion gases are fed to the turbine 9, wherein for example the first turbine stage is subject to a turbine entry temperature of around 750° C. to 1200° C. Expansion and cooling of the hot gas flowing through the turbine stages takes place in the turbine 9 (see FIG. 1).

During the operation of the gas turbine 1, fresh air L is taken in from the ambient air. The air L is compressed in the compressor 3 and preheated at the same time as a result. Air K₁, K₂ compressed in the compressor is extracted from the compressor 3 at a cooling air extraction point 61, 63. The cooling air extraction point 63 hereby corresponds to a lower level of compression of the air L. The compressed air K₁, K₂ is fed to the primary sides of the heat exchanges 43, 45 via the cooling air ducts 39, 41. The compressed air K₁, K₂ is cooled in the exchange of heat with the air stream SI, S₂. The cooled compressed air K₁′, K₂′ is then fed to the gas turbine 1 to cool areas 65, 47 subject to thermal loading. The heat exchange process in the air-air heat exchanger 43, 45 causes the air stream S₁, S₂ fed to the secondary side of the heat exchanger 43, 45 to be heated. The heated air stream S₁′, S₂′ is fed to the air turbine 35, where it expands in a manner that provides work output.

The invention is characterized in particular in that an air turbine 35 and an air-air heat exchanger 43, 45 are also connected in a gas turbine installation 31 of a gas turbine 1. An air compressor 33 is hereby advantageously assigned to the air turbine 3, via which a compressed air stream S₁, S₂ is forwarded to the secondary side of the heat exchangers 43, 45. The maximum pressure of the air stream S₁, S₂ extracted from the air compressor 33 is typically around 2 to 2.5 bar. The temperature of the air stream S₁, S₂ before the heat exchange process is for example 100° C. to 110° C. In the heat exchanger 43, 45 compressed air K₁, K₂ from the compressor 3 of the gas turbine 1 is cooled and the air stream S₁, S₂ is heated. The air stream S₁′, S₂′ heated thus is fed to the air turbine 35, where it expands, thereby generating mechanical or electrical energy via the generator 37 coupled to the air turbine 35. The compressed air K₁′, K₂′ cooled to around 120° C. to 150° C. is fed via a respective cooling air duct 39, 41 to the turbine 9 for cooling purposes.

Significantly lower temperatures of the cooling air K₁′, K₂′ used to cool a gas turbine 1 are achieved with the invention. This means on the one hand that it is possible to reduce the use of cooling air, i.e. the cooling air mass flow extracted from the compressor 3 or on the other hand to increase the entry temperature of hot gas into the turbine 9. Both measures advantageously result in an increase in the efficiency of the gas turbine installation 31. Also the energy generated in the air turbine 35 in turn contributes to the increase in efficiency.

1. Method for cooling a gas turbine (1), wherein compressed air (K₁, K₂) is extracted from a compressor (3) connected upstream from the gas turbine (1) and fed to the gas turbine (1) as cooling air, wherein the compressed air (K₁, K₂) is cooled in the exchange of heat with an air stream (S₁, S₂) and cooled compressed air (K₁, K₂) is fed to the gas turbine (1) for cooling purposes.

2. Method according to claim 1, wherein the air stream (S₁, S₂, S₁′, S₂′) is conducted independently of the compressed air with regard to flow technology.

3. Method according to claim 1 or 2, wherein the compressed air (K₁, K₂) is cooled in the exchange of heat to 120° C. to 150° C. in particular to 130° C. to 140° C.

4. Method according to claim 1, 2 or 3, wherein an air stream (S₁, S₂) with a temperature of 90° C. to 115° C., in particular 100° C. to 110° C. is used for the exchange of heat.

5. Method according to one of the preceding claims, wherein an air stream (S₁, S₂) with a maximum pressure of 2 bar to 3 bar, in particular 2 bar to 2.5 bar, is used for the heat exchange.

6. Method according to one of the preceding claims, wherein the air stream (S₁, S₂) heated during the exchange of heat is fed to an air turbine (35) and expanded there in a manner that provides work output.

7. Gas turbine installation (31), in particular for implementing the method according to one of claims 1 to 6, with a gas turbine (1) and a compressor (3) connected upstream from the gas turbine (1), wherein at least one cooling air duct (39, 41) extends from the compressor (3), via which compressed air (K₁, K₂) can be extracted from the compressor (3) and fed to the gas turbine as cooling air (K), wherein the primary side of an air-air heat exchanger (43, 45) is connected to the cooling air duct (39, 41), the secondary side of said heat exchanger being connected to a duct (47, 49), via which an air stream (S₁, S₂) can flow through the heat exchanger (43, 45).

8. Gas turbine installation according to claim 7, wherein upstream of the heat exchanger (43, 45) the duct (47, 49) is connected to an extraction point (53, 55) of an air compressor (33) to extract the air stream (S₁, S₂).

9. Gas turbine installation according to claim 7 or 8, wherein downstream of the heat exchanger (43, 45) the duct (47, 49) opens out into an air turbine (35) connected downstream from the air compressor (33).
